(19) United States
(12) Patent Application Publication
(10) Pub. No.: US 2018/0026429 A1
(43) Pub. Date: Jan. 25, 2018

(54) Cable Stripping Tool

(71) Applicant: Tavismanor Limited, Stanway (GB)

(72) Inventors: Barry Peter LIVERSIDGE, Langham (GB); George Henri LIVERSIDGE, Stanway (GB)

(21) Appl. No.: 15/550,959

(22) PCT Filed: Feb. 18, 2016
(86) PCT No.: PCT/GB2016/050404

§ 371 Date: Aug. 14, 2017

(30) Foreign Application Priority Data
Feb. 18, 2015 (GB) 1502743.6
Aug. 5, 2015 (GB) 1513855.5
Sep. 18, 2015 (GB) 1516583.0
Sep. 18, 2015 (GB) 1516585.5

(51) Int. Cl. H02G 1/12

(52) U.S. Cl. CPC H02G 1/1226

(57) ABSTRACT

This invention relates to a tool for stripping a sheath from a sheathed cable. A tool for stripping a sheath from a sheathed elongate cable of substantially circular cross-sectional shape, comprises a tool body having a bore for receiving an end portion of a cable to be stripped; a cutting blade having a cutting end and a rear end opposed to the cutting end, the cutting blade being mounted in a slot within the tool body with the cutting end accurately positioned and aligned in the bore to sever a helical strip of sheath from the end portion of a cable received in the opening on rotating the tool around the cable; characterised in that the slot houses the cutting blade and has an open end, the blade being slidably received, rear end first, in the slot from the open end thereof and an abutment within the slot is engaged by the rear end of the blade whereby the cutting end is accurately positioned and aligned within the bore.

### BACKGROUND

### a. Field of the Invention

This invention relates to a tool for stripping a sheath from a sheathed cable. In particular, though not exclusively, this invention relates to a tool for stripping insulation in the form of a sheath from the end portion of a round electrical cable. This invention further relates to a tool for stripping a layer of insulation surrounding a conducting core of a round electrical cable, and/or for stripping an outer sheath surrounding such a layer of insulation, from an end portion of the cable.

### b. Related Art

Tools for stripping an outer sheath or a layer of insulation from a cable, such as an electrical cable having a central conducting core, are conventionally known as wire stripping tools.

Wire stripping tools are widely known and used throughout the electrical industries, for stripping insulation from a very wide variety of cable and wire types. Wire stripping tools have been developed to strip a fixed or chosen length of insulation or outer sheath from such cables and though some of these are more effective than others, they are known to suffer from certain disadvantages. Some of the known cable or wire stripping tools have a large number of different parts which can lead to difficulties in the manufacture and assembly. Furthermore, some tools may have sharp blades exposed and so represent a significant health and safety risk. Other tools may be difficult or inconvenient to use.

In order not to damage the cable, the cutting edge of a blade must be accurately positioned and aligned relative to the cable to be stripped. In particular, the blade should be positioned so as to avoid damaging the electrical conductor of the cable. The requirement to accurately position and align the blade leads to manufacturing complexity.

Additionally, it is known that cables of a defined conductor core area (such as 16 mm² or 25 mm²) may have significantly different insulation thicknesses and (if provided) outer sheaths. Variations are found as between different manufacturers and even for cables from the same manufacturer, due to manufacturing tolerances when moulding the insulating layer and the outer sheath therearound. If a cable of an expected size is to be stripped with a tool pre-set and configured for that cable size, it has been found that it may not be possible to achieve an effective strip if the outer diameter of the cable is smaller than expected for a “typical” cable; and conversely if the cable is larger than expected, the removal of the outer sheath may damage the insulating layer and the removal of the insulating layer may damage the central electrical conductor(s).

A particular problem arises in domestic electrical installations where heavy duty cables having a defined conductor core area (usually of 16 mm² or 25 mm²) connect an electricity supply meter to a component such as an isolator switch, a connector block or a consumer unit (any one of which is hereinafter referred to simply as a “component”). With a national programme (in the UK) for the roll-out of so-called smart meters there is a requirement for very large numbers of cable stripping operations to be performed on the in-coming cables to the smart meter and between the smart meter and a component. Further, safety requirements demand that each stripping operation is performed to a defined specification with tight tolerances appropriate for the connection to be made. If the exposed length of the conductors is too long, there is the possibility of the conductors being exposed at a connection, and also a consumer might be able to gain access to the conductors of the in-coming cables, up-stream of the meter. Conversely, if the exposed length of the conductors is too short, then an inadequate connection might result.

Typically, the stripping operations must be performed to two different strip specifications: a first for a cable end portion to be connected to a smart meter and a second for a cable end portion to be connected to a component. An electrician must, therefore, carry sufficient tooling to allow cable stripping to be performed to two different specifications, on two different cable sizes (usually 16 mm² or 25 mm² for the domestic environment). Further tooling may also be required if cables having only an insulation layer (i.e. no outer sheath) and cables having both an insulation layer and an outer sheath are both to be stripped. An electrician must select the appropriate tool for the connection to be made, but in view of the number of stripping tools that must be carried it is relatively easy for an electrician to perform at least a first strip with the wrong tool.

It is an aim of the present invention to overcome at least one of the problems with known prior art cable stripping tools. In particular, it is an aim of the present invention to provide a tool for stripping a surrounding layer from a cable of a known conductor area which is very simple and cost effective to manufacture and has few parts, but which provides an accurate and precise stripping action for stripping either the outer sheath or the insulation from the cable.

### SUMMARY OF THE INVENTION

According to a first aspect of the present invention there is provided a tool for stripping a sheath from a sheathed elongate cable of substantially circular cross-sectional shape, comprising:
a tool body having a bore for receiving an end portion of a cable to be stripped;
a cutting blade having a cutting end and a rear end opposed to the cutting end, the cutting blade being mounted in a slot within the tool body with the cutting end accurately positioned and aligned in the bore to sever a helical strip of sheath from the end portion of a cable received in the opening on rotating the tool around the cable;
characterised in that the slot houses the cutting blade and has an open end, the blade being slidably received, rear end first, in the slot from the open end thereof and an abutment within the slot is engaged by the rear end of the blade whereby the cutting end is accurately positioned and aligned within the bore.

It will be appreciated that in its simplest form, the tool may comprise a plastics material moulding and the cutting blade which is received in the slot in the tool body. The cutting end of the blade is accurately positioned and aligned within the bore to perform the stripping action on rotation of the tool around the cable, by the engagement of the rear end of the blade with the abutment within the slot. Any pressure on the cutting end of the blade caused by the cutting action will press the rear end of the blade more firmly into engagement with the abutment, so eliminating the possibility of the cutting end of the blade moving away from its intended position.

In a preferred embodiment, the end of the slot (or each slot, if there is more than one) remote from the open end is essentially closed, for example by a transverse wall which extends across the end of the slot, the transverse wall defining the abutment for engagement by the rear end of the cutting blade. The abutment could be the wall itself, in which case the wall may have a concave surface, the rear end of the cutting blade being correspondingly convex for engagement with the concave surface of the transverse wall. An alternative would be for there to be a protrusion formed on the wall for engagement by the rear end of the blade. Yet another possibility is for the abutment to be defined by a projection into the slot from the tool body, or by a pin, bar or other element fitted into the tool body to extend into the slot. Various abutment shapes and profiles may be employed so long as the rearward movement of the blade is limited and defined by the engagement of the rear end of the blade with the abutment.

Preferably, the slot has a complementary cross-section to that of the cutting blade whereby the cutting blade is constrained against movement other than in the direction between its cutting and rear ends. For example, the slot may have side walls extending from the open end thereof to the remote end of the slot, and the cutting blade has side flanks extending between the cutting and rear ends thereof, each side flank being a sliding fit against the corresponding wall of the slot. In the preferred embodiment both the slot and the cutting blade are of substantially rectangular cross-section but it will be appreciated that the blade may be sufficiently held against movement other than along its length by non-rectangular regular or irregular cross-sectional shapes but not circular.

In one embodiment, the slot is defined by side walls formed in the body, a channel being provided in one of the side walls to extend along the length thereof, thereby giving access to a cutting blade located in the slot. This may be used to assist removal of a worn or damaged blade, and the fitting of a new blade into the slot.

An aperture may be formed through a side face of the tool to communicate with the cutting end of the cutting blade whereby sheath cut from a cable may leave the cable-receiving opening through the aperture. The bore has an end wall defining the maximum insertion depth of a cable end portion being stripped, by the conductors of the cable engaging the end wall. This prevents further advancement of the tool along the cable end portion and gives a clean radial profile to the end of the remaining sheath.

A tool of this invention may have a bore with two slots associated therewith, at substantially diametrically-opposed locations and arranged to sever sheath at two different radii with respect to the cable end portion. By having the two slots out of alignment along the axis of the tool, a two-level strip of sheath may be obtained with the tool.

Preferably, the bore is cylindrical and of a diameter adapted to receive a known cable size. The diameter of the bore may be stepped along its length, to assist the location of the cable in the bore, the largest diameter of the bore being adapted to receive the unstripped cable, and the smallest the conductors. Further, the tool body may have two opposed axially-aligned bores, each having at least one slot associated therewith, and in this case the two bores are of different diameters, each adapted to receive a known but different cable size.

In some embodiments the cutting blade has facets which define the cutting edge of the blade and the blade is mounted in the tool body such that the cutting edge extends along a chord of the bore with the cutting edge lying in a non-radial plane whereby rotation of the tool about a cable end portion received in the opening causes the tool to create a helical cut along the cable end portion, thereby severing a helical strip of the surrounding layer as the tool moves along the cable end portion.

In a preferred form of the tool, the cutting blade has a further edge extending generally at right angles to the cutting edge and lying in a plane which is parallel to a tangent to the outer surface of the outer layer, whereby the further edge serves to lift the severed layer from the cable end portion. The further edge may be sharp to assist the removal of the severed strip of the outer layer, for example where the outer layer is bonded to an underlying layer or the conducting core.

In some embodiments a tool for stripping a surrounding layer from an elongate electrical cable of substantially circular cross-sectional shape, comprises: a tool body having opposed jaws, said jaws being moveable relative to each other from an initial position; a cable-receiving opening defined by formations in each of the jaws, the opening being configured to accommodate the end portion of a cable to be stripped with the formations fitting closely against the surrounding layer of the cable; and a cutting blade mounted in one of the jaws and having a cutting end positioned in the opening to penetrate to the surrounding layer to a pre-set depth. Such a tool is characterised in that the cutting end of the cutting blade has a cutting edge defined by facets of the blade disposed at an angle to the axis of the opening thereby to sever a helical strip of surrounding layer from the end portion of a cable received in the opening on rotation of the tool around the cable and in that the jaws are resiliently separable and move away from each other from the initial position to allow the cable-receiving opening to accommodate therein the end portion of a cable of a diameter greater than the size of the opening when the jaws are in the initial position, to ensure the formations fit closely against the surrounding layer to ensure the pre-set depth of cut is delivered into the layer.

It will be appreciated though the tool is configured for stripping a cable having a single conducting core of a defined conductor area (such as 16 mm² or 25 mm²), the tool is able to perform effective stripping of a wide variety of such cables perhaps from different manufacturers or at different extremes of the manufacturing tolerances, by the jaws separating to the required extent to accommodate a chosen cable pushed into the opening of the tool. In this way, a clean and effective strip can be obtained, without damaging the conductors of the core or without damaging the insulation layer in the case of a sheathed cable, when removing the outer sheath from the insulation.

In its simplest form, the tool body and the opposed jaws may comprise a plastics material moulding with a slot between the jaws, whereby resilient deformation of the plastics material allows the jaws to move away from each other. Alternatively, the tool body may be formed in two parts each having one of the opposed jaws, the two parts being connected together by means allowing separation of the jaws to be resiliently increased. This may be achieved by providing a resilient band (such as a rubber or silicone rubber band) encircling the tool body, under tension. Though the band may encircle the opposed jaws, preferably the band encircles the tool body remote from the jaws. Another possibility is to use a spring clip, such as a C-shaped clip of spring metal to hold together the two parts of the tool while allowing the opposed jaws to separate resiliently.

In an alternative embodiment, a fastener may be provided to clamp together the two parts of the tool remote from the jaws, whereby resilient deformation of the plastics material allows the jaws to move away from each other. The plastics material may be given the required characteristics by appropriate selection of the material from which the parts are moulded, or perhaps by a co-moulding operation incorporating a more resilient plastics material into the tool body. A fulcrum may be provided between the two parts of the tool, the fastener being arranged to hold together the two parts of the tool remote from the jaws. In this case a spring may be disposed between the two parts to urge together the opposed jaws, or reliance may be placed on the resilient deformation of the plastics material as aforesaid.

An abutment such as an internal transverse wall may be provided within the tool body for engagement by the free end of a cable received in the opening, thereby to limit the length of surrounding layer which can be stripped from the cable end. An enlarged space may be provided within the tool adjacent the abutment, to allow room for the accommodation of a damaged cable end or conductors.

To allow the stripping of a cable having a single surrounding layer, or the outer sheath for a cable having two layers, the cable receiving opening may have a substantially constant cross-section. If the tool is to be used to strip a layer of insulation following the stripping of an outer sheath, the opening may have an outer part which fits closely to the sheath of the cable end and an inner part which fits closely to the exposed insulation of the cable end, and which serves to constrain movement of the cable end during the stripping action.

Preferably, an aperture is formed through a side face of the tool to communicate with the cutting end of the cutting blade whereby a helical strip of the surrounding layer cut from a cable may leave the cable-receiving opening through the aperture.

A particularly preferred form of tool of this invention has first pair of opposed jaws and a second pair of opposed jaws, each pair having a cable receiving opening defined by formations in the jaws, the jaws being arranged such that the cable-receiving openings thereof are axially-aligned, and each opening having a cutting blade positioned therein. The configuration of the formations of the two pairs of jaws may be different to allow the performance of a two-level strip on a cable having an insulating layer surrounding the conducting core and a sheath surrounding the insulating layer.

In some embodiments the tool for stripping a surrounding layer from an elongate electrical cable of substantially circular cross-sectional shape comprises: a tool body defining a cable-receiving opening configured to accommodate the end portion of a cable to be stripped, the opening being configured to fit closely against the surrounding layer of the cable end portion; a cutting blade mounted in the tool body and having a cutting edge positioned in the opening to penetrate the surrounding layer of a cable entered therein to a pre-set depth, the cutting edge of the cutting blade being defined by facets of the blade disposed at an angle to the axis of the opening thereby to create a helical cut along the end portion of a cable received in the opening on rotation of the tool around the cable and sever a helical strip of the surrounding layer from the cable; and a cable end stop arrangement provided within the tool body for engagement by the end of the cable being stripped thereby to limit the length of the helical cut along the cable from the end thereof, the end stop arrangement having first and second abutments disposed at different pre-set distances from the cutting blade; and a manually-operable control to allow selection of either the first abutment or the second abutment for engagement by the cable end.

It will be appreciated that the tool has a single blade set to perform a one-level strip on a cable end portion but the tool may be set to strip one of two pre-defined lengths of a surrounding layer from a cable end portion, by using the control to select the appropriate abutment for the required strip specification.

In another embodiment of this invention the tool for stripping a surrounding layer from an elongate electrical cable of substantially circular cross-sectional shape comprises: a tool body defining first and second cable-receiving openings each configured to accommodate the end portion of a cable to be stripped and being configured to fit closely against the surrounding layer of the cable end portion; a first cutting blade mounted in the tool body and having a cutting edge positioned in the first opening to penetrate the surrounding layer of a cable entered therein to a first pre-set depth; a second cutting blade mounted in the tool body and having a cutting edge positioned in the second opening to penetrate the surrounding layer of a cable entered therein to a second pre-set depth; the cutting edges of the first and second cutting blades being defined by facets of the respective blade disposed at an angle to the axis of the respective opening thereby to create a helical cut along the end portion of a cable received in the opening on rotation of the tool around the cable and sever a helical strip of the surrounding layer from the cable; a cable end stop arrangement provided within the tool body for engagement by the end of the cable being stripped thereby to limit the length of the helical cut along the cable from the end thereof, the end stop arrangement having first and second abutments associated with the first opening and disposed at different pre-set distances from the first cutting blade and further first and second abutments associated with the second opening and disposed at different pre-set distances from the second cutting blade; and a manually-operable control to allow selection, for each opening, of either the first abutment or the second abutment for engagement by the cable end.

With a tool according to this second, and preferred, aspect of this invention, the tool has two cable-receiving openings each having an associated blade to penetrate a cable surrounding layer to a pre-set depth. The two blades could be pre-set to penetrate the surrounding layer to the same depth, and in this case the tool could be arranged to perform one-level strips to four different strip specifications or perhaps on two different cable sizes. Preferably, the blades are pre-set to penetrate the surrounding layer to different depths, whereby the tool can be arranged to perform two-level strips to two different strip specifications or perhaps on two different cable sizes.

In a preferred form of the just-described tool, the two openings are axially aligned in the tool body from opposite ends thereof. There is a cable end stop arrangement for each opening for engagement by the end of the cable being stripped, each end stop arrangement having first and second abutments disposed at different pre-set distances from the respective cutting blade, thereby to limit the length of the helical cut depending upon the selected abutment. The manually-operable control may simultaneously select for each opening either the first abutment or the second abutment.

In a preferred embodiment, the end stop arrangement includes a carrier providing the first and second abutments in a spaced-apart disposition, the carrier being mounted within the tool body for movement between two positions at which either the first abutment or the second abutment is aligned with the opening to provide an end stop for the cable end portion being stripped. Alternatively, the end stop arrangement may comprise a fixed first abutment provided by the tool body and aligned with the opening to provide an end stop for the cable end portion being stripped and a second abutment provided on a carrier mounted within the tool body for movement between two positions at one of which the second abutment is aligned with the opening and is disposed in front of the first abutment thereby to provide an end stop for the cable end portion being stripped.

In either of the above arrangements, the carrier may mounted for rotational movement within the tool body between said positions, the carrier having a lever or tab projecting through a slot in the body to allow manual access thereto, whereby operation of the lever selects the abutment to provide the end stop for the cable end portion being stripped. Alternatively, the carrier may have a recess or other surface engageable by a tool such as a screwdriver inserted through the slot to effect rotation of the carrier. Instead of being rotatable, the carrier may be slidably mounted within the tool body for movement between said limiting positions. For example, the carrier may be mounted within a slot in the tool body so as to project from one side or the other side of the tool body depending upon the selected limiting position.

Each of the first abutment and the second abutment may comprise a wall extending transversely to the axis of the opening when in the active setting, for engagement by the end of a cable being stripped. The abutments may comprise a part of the carrier formed integrally therewith. In the alternative, the abutments may be formed separately of a relatively harder or tougher material than the carrier, to minimise wear by the cut ends of a cable being stripped as the tool is rotated therearound. The abutments may therefore comprise inserts of a metal, a ceramic or other hard material fitted to the carrier.

To allow for variations in cable sizes for example due to manufacturing tolerances or from different manufacturers the tool body may define a pair of opposed jaws which are moveable relative to each other from an initial position, the cable-receiving opening being defined by formations in each of the jaws. With this arrangement, the jaws are resiliently separable and move away from each other from the initial position to allow the cable-receiving opening to accommodate the end portion of a cable of a diameter greater than the size of the opening when the jaws are in the initial position. This ensures the formations fit closely against the surrounding layer to deliver into the layer the pre-set depth of cut.

The invention therefore provides a tool for stripping a protective layer from an elongate cable comprising a main body having a bore for receiving an end portion of a cable to be stripped and a slot in communication with said bore, a first end of the bore forming an opening in a face of the main body; a cutting blade mounted in the slot such that a cutting end of the blade extends into the bore, the cutting end of the blade including a first edge and a second edge, the first edge being substantially perpendicular to the second edge, and wherein the cutting blade in mounted such that the first and second edges lie at a pre-defined distance from the axis of the bore; an aperture in a face of the main body, the aperture being in communication with the slot; and an end stop located proximate or at a second end of the bore to limit the length of cable that is insertable into the bore, wherein, in use, when a cable is rotated within the bore, the first edge of the cutting blade makes a radial cut in the protective layer of the cable and the second edge lifts the cut protective layer, wherein the cutting blade is positioned such that the cut made by the first edge of the cutting blade is a helical cut in the protective layer, and wherein the lifted cut protective layer exits the tool through the aperture.

Preferably the slot includes an open end and a closed end and the cutting blade is slidably received within the slot. The cutting blade is preferably a push fit in the slot no additional securing means are required to retain the cutting blade in the slot. In preferred embodiments there is an obtuse angle between the first and second edges of the cutting blade. The cutting blade may include a sloped surface with the second edge being located at a distal edge of the sloped surface.

In some embodiments the tool comprises a channel in a face of the main body, the channel being in communication with the slot and providing access to a cutting blade housed within the slot. The main body may include two slots in communication with the bore, a cutting blade being housed within each of the slots, and a first one of the slots being positioned nearer an axis of the bore than a second one of the slots. Preferably the first and second slots are at substantially diametrically-opposed locations relative to the bore. The first slot may be located nearer to the first end of the bore than the second slot.

In preferred embodiments the tool comprises two bores for receiving an end portion of a cable, each bore having a slot and a cutting blade associated therewith. The axes of the two bores may be parallel. Preferably the bores extend in opposite directions such that a first end of a first bore forms a first opening in a first end face of the main body and a first end of a second bore forms a second opening in a second end face of the main body. The two bores may be co-axial. Preferably the two bores have different diameters to accommodate cables having different outer diameters. The, one or each bore of the tool may include a first section having a larger diameter than a second section, the first section being located proximate the first end of the bore.

In preferred embodiments the main body comprises a first part and a second part, each of the first and second parts including an elongate channel, and the first and second parts being connected together such that the channels are aligned to form the bore for receiving an end portion of a cable. In these embodiments the first and second parts are preferably connected together proximate the second end of the bore, and the first and second parts are preferably movable away from each other at the first end of the bore so as to create a gap between the first and second parts at said first end. This allows the bore to accommodate a cable having a larger diameter. The main body may include means to urge the first and second parts into contact with each other. In some embodiments the main body is made of a resilient plastics material.

A tool according to the invention preferably further comprises an end stop assembly, the end stop assembly including an abutment surface, and the abutment surface being locatable in alignment with the bore for limiting the length of cable that may be inserted into the bore. Preferably the end stop assembly includes a chassis mounted for rotation within the main body, the abutment surface being provided on the chassis, and the chassis being movable between a first position in which the abutment surface is aligned with the bore and a second position in which the abutment surface is not aligned with the bore. In some embodiments the chassis may include a second abutment surface and the second abutment surface is aligned with the bore when the chassis is in the second position. The first and second abutment surfaces may be located at different radial distances from the axis of rotation of the chassis.

In some embodiments the end stop assembly includes a second abutment surface located in a fixed position in alignment with the bore, and when the chassis is in the first position the abutment surface of the chassis is located between the second abutment surface and the bore. Preferably the chassis includes a slider that is located in a slot in the main body and protrudes from the main body of the tool. Movement of the slider from a first end of the slot to a second end of the slot results in rotation of the chassis from the first position to the second position.

The main body of the tool may include a window and the chassis may include identification means.

In these embodiments the window and the identification means are preferably arranged such that the identification means are visible through the window when the chassis is in the first position and the identification means are not visible through the window when the chassis is in the second position.

In preferred embodiments the tool includes two bores and the chassis includes a pair of abutment surfaces. In these embodiments, when the chassis is in the first position one of the abutment surfaces is aligned with each of the bores.

### BRIEF DESCRIPTION OF THE DRAWINGS

The invention will now be further described by way of example only and with reference to the accompanying drawings, in which:

FIG. 1 is an isometric view of a partially assembled cable stripping tool according to a first embodiment of the present invention;

FIG. 2 is a detail view of a part of the tool of FIG. 1, showing the insertion of a cutting blade into a body of the tool;

FIG. 3 is a detail view of a part of the tool of FIG. 1, with part of the main body of the tool cut away, and showing the cutting blade fully inserted into the body of the tool;

FIG. 4 shows the cable stripping tool of FIG. 1, together with an electrical cable about to be inserted into the tool;

FIG. 5 shows the tool of FIG. 1 in use stripping a layer of insulation from an electrical cable inserted in the tool;

FIG. 6 shows the cable stripping tool of FIG. 1, together with an electrical cable having a two-level strip at the end of the cable;

FIG. 7 shows a part of a second embodiment of a cable stripping tool, including a slot in the body of the tool for receiving the cutting blade;

FIG. 8 is a further view of the slot of FIG. 7;

FIG. 9 illustrates a part of a further embodiment of a cable stripping tool, showing in particular a modified cutting blade of the tool separated from the tool body;

FIG. 10 is a partially cut away perspective view of the tool of FIG. 9 showing the cutting blade installed in the tool body;

FIG. 11 is a partially cut away plan view of the tool of FIG. 9 showing the cutting blade installed in the tool body;

FIG. 12 is an isometric view of a cable stripping tool according to a further embodiment of the present invention the tool, together with an electrical cable about to be inserted into a first end of the tool;

FIG. 13 shows the tool of FIG. 12 with the cable fully inserted therein and about to have outer sheath stripped therefrom;

FIG. 14 shows the tool of FIG. 13 being rotated to strip the outer sheath;

FIG. 15 shows the tool of FIG. 14 removed from the cable with a pre-determined length of outer sheath stripped from the cable;

FIG. 16 shows the cable fully inserted into a second end of the tool of FIG. 12, and the tool being rotated to remove an inner layer of insulation from a conducting core of the cable;

FIG. 17 shows the tool of FIG. 16 removed from the cable with a two level strip completed on the cable;

FIG. 18 is a partly cut away view of the tool of FIG. 12 showing a cable located therein at the completion of the removal of the inner insulation layer from the cable;

FIG. 19 is an isometric view of a cable stripping tool according to another embodiment of the present invention, the tool being configured for performing a two-level strip on an end portion of an electrical cable having an inner insulation layer around a conducting core and an outer sheath around the insulation layer;

FIG. 20 illustrates the tool of FIG. 19 with a part of the body removed and showing an abutment housed within the main body and an end of a cable in contact with the abutment, thereby limiting the length of the cable end portion that is stripped;

FIG. 21 is an exploded view of the tool of FIG. 19, showing the arrangement of a carrier including abutment surfaces in the main body of the tool;

FIG. 22 is an exploded view of the tool of FIG. 19, with the carrier in a first position;

FIG. 23 is an exploded view of the tool of FIG. 19, with the carrier in a second position;

FIGS. 24a and 24b are axial sections through the tool of FIG. 19, showing the carrier in the first and second positions respectively;

FIG. 25a is an axial section through a cable stripping tool according to a further embodiment of the present invention, showing abutment surfaces in a first position; and

FIG. 25b is an axial section through the tool of FIG. 25a, showing the abutment surfaces in a second.

### DETAILED DESCRIPTION

Electrical cables typically have a single conducting core which itself may consist of one or several conductors. The core is typically surrounded by one or more layers. For example, the surrounding layer could comprise a single layer of insulation surrounding the conducting core, or could comprise a layer of insulation surrounding the core and an outer sheath surrounding the layer of insulation, for added protection against damage or for identification purposes.

When stripping a cable having a single surrounding layer, removal of a length of that layer from the free end of the cable exposes the conducting core to allow the cable to be electrically connected to some other component. Such a strip is usually referred to as a “one-level strip”. When stripping a cable having a layer of insulation and an outer sheath around the insulation, a one-level strip may be performed by removing the same lengths of both the outer sheath and the insulation. Alternatively, a greater length of outer sheath may be removed than the length of insulation, giving rise to a so-called “two-level strip” where a short length of insulation is exposed between the exposed conducting core and the outer sheath.

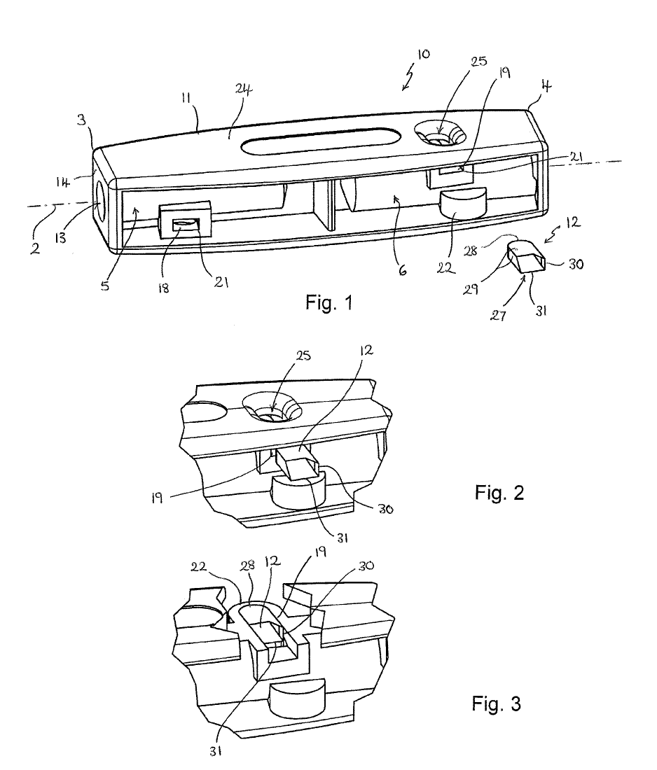

A first embodiment of a cable or wire stripping tool 10 is illustrated in FIGS. 1 to 6. The wire stripping tool 10 comprises a main body 11 and at least one cutting blade 12. The main body 11 is preferably made from a suitable plastics material and will typically be injection moulded.

The main body 11 is generally elongate and an axis 2 of the main body 11 extends between first and second ends 3, 4. The main body 11 includes a cable-receiving opening 13 in a first end face 14. The opening 13 is at one end of a first axial bore 5 that extends from the first end 3 of the main body 11 towards the second end 4. A second cable-receiving opening 15 is formed in a second end face 16 of the main body 11, and a second axial bore 6 extends from the second end 4 of the main body towards the first end 3. The two bores 5, 6 are of different diameters; typically, the first bore 5 is sized to receive a cable with a single layer of insulation whereas the second bore 6 is sized to receive a larger cable with two layers of insulation, or a layer of insulation and an outer sheath. A diameter of the second bore 6 at the opening 15 is, therefore, larger than a diameter of the first bore 5 at the opening 13. Both bores 5, 6 are blind bores and are closed by an end wall at the end furthest from the first and second openings 13, 15 respectively. The length of the bores 5, 6 limits the length of insulation to be stripped from a cable. In other embodiments the ends of the bores 5, 6 furthest from the openings 13, 15 are open ends and the main body of the tool includes a stop plate extending transverse to the axis of the bores. In these embodiments a cable end may be inserted into the bore until an end face of the cable contacts a surface of the stop plate.

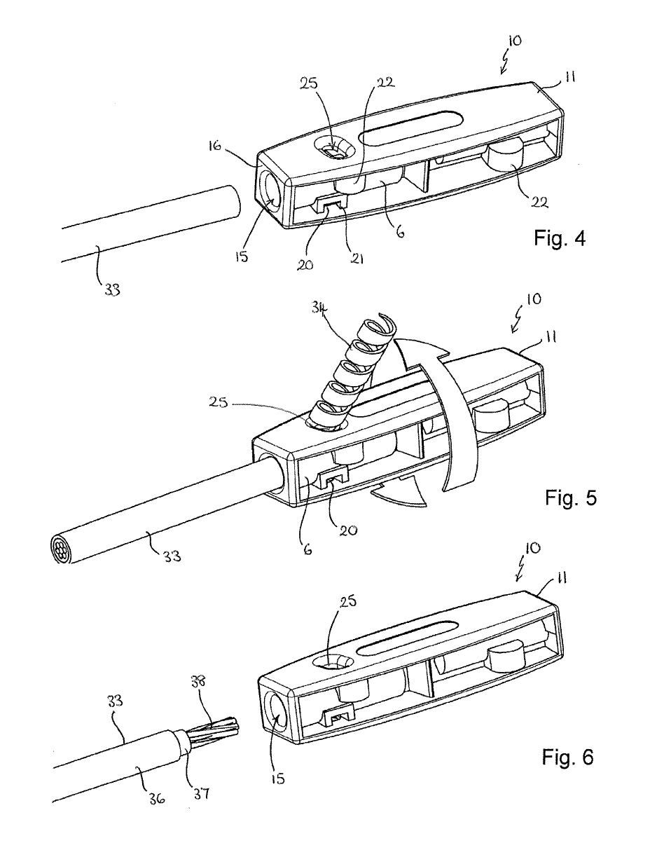

The main body 11 further includes three slots 18, 19, 20, shown most clearly in FIGS. 1 and 4. These slots will typically be moulded into the tool body. A first slot 18 is associated with bore 5 and extends thereacross, such that an axis of the slot 18 is transverse to an axis of the bore 5. A second slot 19 is associated with bore 6 and extends thereacross, such that an axis of the slot 19 is transverse to an axis of the bore 6. A third slot 20, visible in FIG. 4 (which shows the tool turned through 180° to present the larger bore 6 to a cable for stripping), is also associated with bore 6 to extend thereacross. An axis of the third slot 20 is transverse to the axis of the bore 6 and, in this example, the axis of the third slot is substantially parallel to the axis of the second slot 19.

The third slot 20 is formed on the other side of the bore to slot 19, and out of radial alignment with slot 19. In other words, the slots 19, 20 are formed on opposite sides of the axis of the bore 6 and are located at different radial distances from the axis.

Each of the slots 18, 19, 20 is of rectangular cross-sectional shape and has an open end 21 and a closed end 22. The open end 21 of each slot is remote from the bore with which the slot is associated and the closed end of each slot lies on the other side of the associated bore and is closed by a moulding formed as a part of the tool main body 11.

A cutting blade 12 is associated with each slot 18, 19, 20. Each cutting blade 12 is of generally rectangular cross-sectional shape having a cutting end 27, a rounded rear end 28 and planar side flanks 29. The cutting end 27 provides two cutting edges 30 and 31 disposed substantially at right angles to each other and configured to perform the required cutting of insulation from a cable to be stripped. In some embodiments it may be advantageous to have one cutting edge sharp and the other relatively blunt, to suit certain cable types.

Three blades 12 are provided, one for each slot 18, 19 and 20 and each blade is a sliding fit in the respective slot. As shown in FIGS. 1 and 2, each cutting blade 12 is inserted into its respective slot 18, 19, 20 with the rear end 28 leading. The blade 12 is press-fitted into its slot 18, 19, 20 until the rear end 28 engages or abuts the closed end 22 of the slot 18, 19, 20. When fully inserted in this way, the two 20 cutting edges 30, 31 of the blade 12 extend into the respective bore 5, 6. The slots and blades are sized such that the cutting edges 30, 31 are accurately positioned and aligned within the bore, to perform the required stripping operation. In particular, the first cutting edge 30 is located such that the cutting edge extends transverse to the bore. When, in use, a cable is located in the bore the first cutting edge 30 makes a radial cut through a layer of insulation or a sheath of the cable. The second cutting edge 31 extends substantially parallel to the axis of the bore and is positioned such that the second cutting edge 31 pushes underneath the cut layer of insulation or sheath to lift the insulation or sheath away from the underlying conductor core or insulation layer respectively. In other embodiments, instead of the blade being press-fitted into the slot, it could be retained therein by other means such as by gluing or other mechanical retention means.

The two cutting blades 12 associated with the larger diameter bore 6 have their cutting edges disposed at different radii so that one of the blades will remove the outer sheath layer from a cable having two such layers, and the other blade will remove the inner layer from the conductors. The slots are disposed out of axial alignment along the bore 6, so that the blade at a greater radius cuts the outer layer first and the blade at the smaller radius cuts the inner layer subsequent to removal of the outer layer. This means that the blade 12 positioned at the greater radius, i.e. further from the axis of the bore, is located nearer the opening 15 at the end of the bore 6 than the blade 12 positioned at the lesser radius, i.e. nearer the axis of the bore. It will be appreciated that a single blade, such as that associated with the smaller diameter bore 5, may remove a single layer around the conductors, or may remove two layers of the sheath with one cut.

Though not shown in the drawings, the bores 5, 6 may have a reducing diameter from the respective end face 14, 16. For example, the reduction in bore diameter may be substantially step-wise, with the smaller diameter at the inner end of the bore, closest to the closed end, and sized to accommodate the conductors when stripped. In the case of a cable having two layers, there may be an intermediate diameter in the bore, for accommodating part of the cable with the outer layer stripped but with the inner insulating layer still surrounding the conductor core, as the stripping action progresses.

The tool main body 11 has opposed side faces 24 extending between the end faces 14,16 and in those side faces are formed apertures 25 which break into or extend into the respective bore 5, 6, in general alignment with the associated slot 18, 19, 20. As shown, each aperture 25 has a generally rounded profile but is sufficiently small to prevent manual access to the cutting blade 12.

FIG. 4 shows the completed tool 10 described above but turned so that the larger bore 6 is presented ready to receiving an electrical cable 33, to strip insulation from that cable. As described above, bore 6 has two cutting blades 12 associated therewith and disposed in respective slots 19, 20 on opposite sides of the bore 6, such that the aperture 25 associated with one slot opens through one side face 24 of the main body 11 and the aperture (not visible in FIG. 4) associated with the other slot opens through the other, opposite side face of the main body 11.

In use, the tool 10 is pushed on to the cable 33 until the cutting blade 12 located in the radially outer slot 19 engages the sheath. The tool 10 is then rotated around the end portion of the cable 33 as shown by the arrows in FIG. 5. Rotation of the tool about the axis of the main body 11 cuts a helical strip 34 of the sheath 36 away from the cable 33, as the tool 10 advances along the end portion of the cable 33, from the free end. This helical strip 34 of the sheath 36 exits the bore 6 and the main body 11 of the tool 10 through the aperture 25 that is in communication with the bore 6 and the slot 19. The opposed blade 12 in the radially inner slot 20 also performs a cut on the cable 33 and removes insulation 37 as the tool 10 is rotated. The helical strip of insulation 37 that is removed exits the bore 6 and the main body 11 through the aperture that is in communication with the bore 6 and the slot 20; however, for the sake of clarity, the helical strip of removed insulation leaving the tool through the lower aperture is not shown.

Rotation of the tool 10 is continued until the conductors 38 within the cable 33 engage or contact the end wall of the bore 6. Further advancement of the tool 10 along the cable 33 is, therefore, prevented and the helical cutting action ceases. When the tool 10 is rotated about its axis 2 with the end of the cable 33 in contact with the end wall of the bore 6, only circumferential cutting is performed by the blades 12, giving a clean radial profile to the sheath. The tool 10 is then pulled away from the cable 33, as shown in FIG. 6. The end portion of the cable 33 thus has a two-level strip, with a greater length of the outer sheath 36 cut from the free end of the cable than the length of the inner sheath 37 due to the relative positions of the blades 12 in the slots 19, 20.

It will be appreciated that the cable stripping tool 10 of the present invention is a hand tool and, accordingly, the main body 11 of the tool 10 is sized to be held in a person's hand. Furthermore, the force required to cut and strip the cable 33 using the tool 10 is such that the tool can be twisted around the cable by hand and does not require any additional leverage or force.

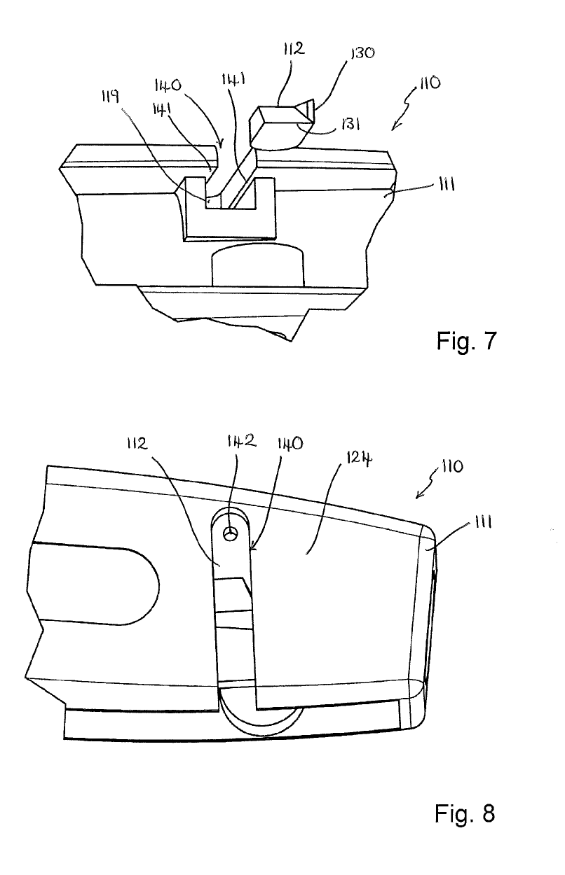

FIGS. 7 and 8 show an alternative slot design for a cable stripping tool 110, as compared to that described above. Many of the features of the tool 110 are the same as those of the tool 10 described above and are indicated by reference numerals incremented by 100. These features will not be described further here. In this embodiment, the side face 124 of the main body 111 of the tool 110 has a channel 140 formed therethrough in alignment with the slot 119 for the blade 112, the channel 140 being of a lesser width than the width of the slot 119, such that on each side of the channel is formed a ledge or overhang 141. The blade 112 is thus constrained within the slot 119 in exactly the same way as has been described above with reference to FIGS. 1 to 6, but access may be gained to the blade 112 through the channel 140, to facilitate changing of the blade 112 in the event that the cutting edges 130, 131 become blunt or are otherwise damaged. For this purpose, the blade 112 is provided with a hole 142 into which an appropriate spike or rod may be inserted, for pulling the blade 112 out of the slot 119. The hole 142 may not extend through the full thickness of the blade 112. With the blade 112 located in the slot 119, the hole is accessible through the channel 140. On replacing the blade 112, that hole 142 may also be employed to pull the blade 112 back to the closed end of the slot 119, so obviating risk of injury on the sharp cutting edges of the replacement blade 112.

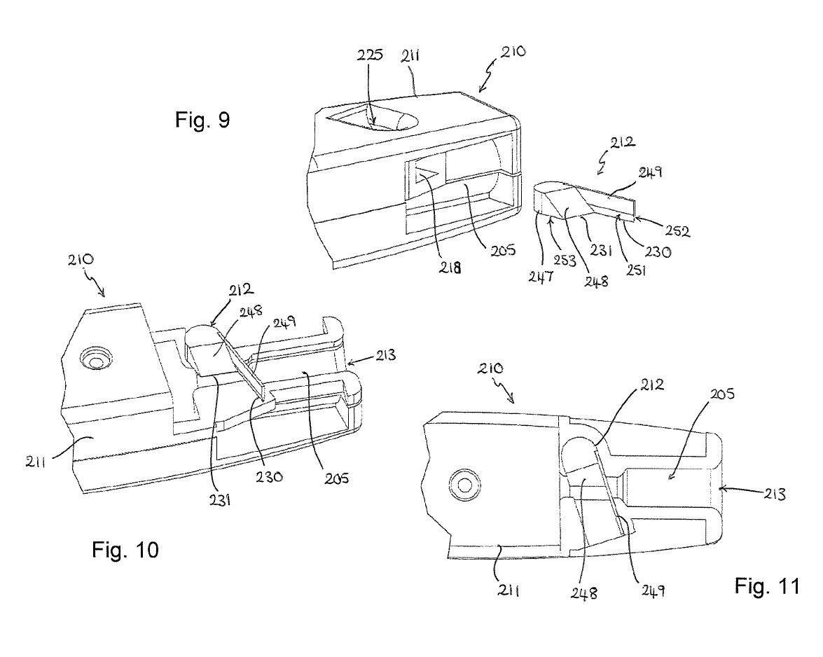

A third embodiment of a cable stripping tool 210 includes a modified cutting blade 212. This modified cutting blade 212 is illustrated in FIGS. 9 to 11. The cutting blade 212 is designed to locate in a main body 211 of a tool 210 substantially identical to the main body 11 described above in relation to the first embodiment of the tool 10. Furthermore, as with the cutting blade 12 of the first embodiment the modified cutting blade 212 is designed and configured to cut or sever a helical strip of a surrounding layer from a cable end portion. As described above, the surrounding layer to be stripped from a cable end portion may be an insulation layer immediately overlying the conductors of the cable or it may be an outer sheath overlying an insulation layer.

In preferred embodiments the cable stripping tool 210 is intended for use with a cable having both an insulation layer and an outer sheath surrounding the insulation layer, the tool being configured to perform a two level strip on the cable end portion, to two different strip specifications. After that strip has been performed, the conductors at the end of the cable are exposed for a pre-set distance back from the cable end face, and also a short length of the insulation layer is exposed along the cable back from the exposed conductors. The tool could however be configured to perform one-level strips to four different strip specifications.

Referring to FIGS. 9 to 11, part way along the length of a bore 205 extending from a respective cable receiving opening 213 in the tool main body 211 there is a slot or socket 218 in which is installed a cutting blade 212, so as to lie in part within the axial bore 205. Only one bore and socket is shown in the drawings, but it will be appreciated from the foregoing embodiments that the tool may comprise more than one bore, each bore having at least one socket associated therewith. The cutting blade 212 is formed in two linked parts; a base part 247 having a ramp surface 248 and a knife part 249 having a cutting edge 230, the two parts being interlinked to define the relationship between the ramp surface 248 and the cutting edge 230. The cutting edge 230 is defined by facets 251, 252 of the knife part 249 lying at an acute angle to each other. As defined, the cutting edge 230 is linear and when the cutting blade 212 is installed in the socket 218 of the main body 211 the cutting edge 230 extends along a chord of the bore 205, at a shallow angle to a true radial plane of the axial bore 205.

The base part 247 of the cutting blade 212 has a planar under-surface 253 which, when installed in the socket 218, lies in a plane substantially parallel to a tangent of the bore 205, the ramp surface 248 and under-surface 253 together forming an edge 231 which lies at an obtuse angle to the cutting edge 230. Unless the outer sheath of a cable is bonded to the insulation layer or the insulation layer is bonded to the conductors, the edge 231 does not need to be especially sharp as it does not perform a cutting action; rather it merely lifts the layer severed by the knife part 249, away from the underlying layer or conductors so that the severed strip may leave the tool body through the aperture 225.

Though the cutting blade 212 is shown as having two linked parts, it could be made in one piece. Also, the edge 231 could be sharp, to allow a cutting action for stripping a cable where the layers are bonded to each other or to the conductors.

The cable stripping tool 210 having the modified cutting blade 212 illustrated in FIGS. 9 to 11 is used in the same manner as the cable stripping tool 10 of the first embodiment and will not be described again here.

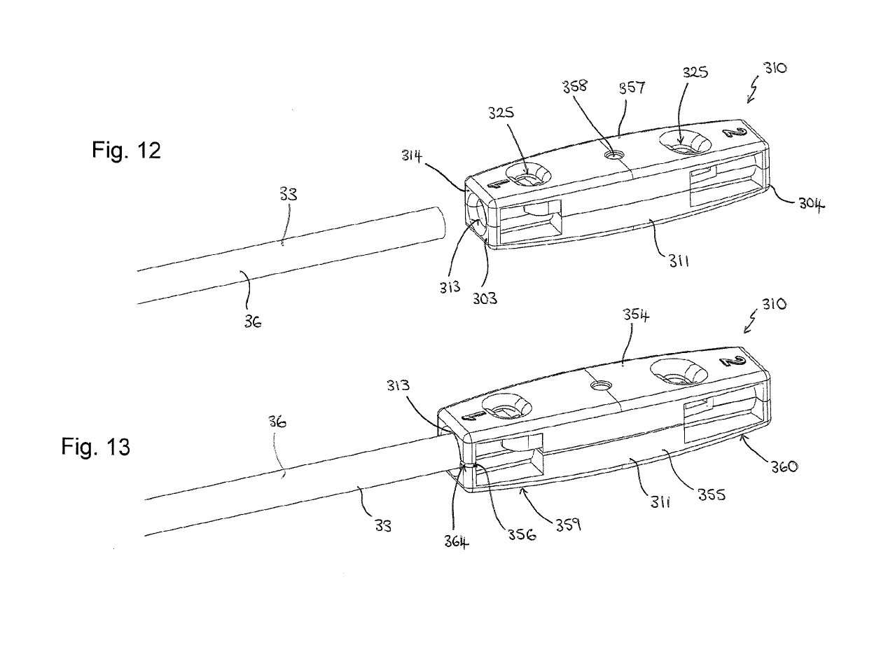

A fourth embodiment of a cable stripping tool 310 is illustrated in FIGS. 12 to 18. In particular, there is shown a hand tool configured to perform a two-level strip on a cable 33 having an inner conducting core 38, a layer of insulation 37 around the core 38 and an outer sheath 36 surrounding the insulation 37. The tool comprises a main body 311 comprising two parts or two longitudinal halves 354, 355. The main body 311 is elongate extending between first and second ends 303, 304. The main body 311 is preferably made of a suitable plastics material and will typically be injection moulded. The two parts 354, 355 of the main body 311 have confronting or opposing faces 356, which may be substantially planar or curved. The two parts 354, 355 are fixed or clamped together in a central region 357 substantially midway between the first and second ends 303, 304 of the main body 311. In this embodiment the two parts 354, 355 are connected together by means of a rivet 358 extending through both the first and second parts 354, 355. In this way, the main body 311 includes a central region 357 from which aligned first and second pairs of opposed jaws 359, 360 project in opposite directions, terminating at first and second end faces 314, 316 of the main body 311. Each jaw 359, 360 includes a section of each of the two parts 354, 355.

The confronting faces 356 of each pair of opposed jaws 359, 360 have formations therein in the form of channels having a semi-circular cross-sectional shape. Accordingly, when the two parts 354, 355 are connected, the opposed channels align in each pair of opposed jaws 359, 360 to create a bore 305, 306 having a substantially circular cross-sectional shape. Generally circular cable-receiving openings 313, 315 are, therefore, defined in the first and second end faces 314, 316 of the main body 311. A first bore 305 in the first pair of opposed jaws 359 has a substantially uniform cross-section, and a second bore 306 in the second pair of opposed jaws 360 has a stepped profile such that the bore 306 has an outer section 362 nearest the opening 315 of substantially the same cross-section as the first bore 305 and an inner section 363 furthest from the opening 315 of a lesser or smaller cross-section.

A respective cutting blade 312 is mounted in one jaw of each pair 359, 360, to sever or cut a layer from a cable 33 (either the outer sheath 36 or the insulation 37) depending on which the bore 305, 306 the cable 33 is inserted into. This cutting operation occurs when the tool 310 is rotated about the cable 33 as described below. Accordingly, with the two parts 354, 355 of the main body 311 connected together and the blades 312 housed in their respective jaw 359, 360, the tool 310 of this embodiment is substantially similar to the tool 10 of the first embodiment described above.

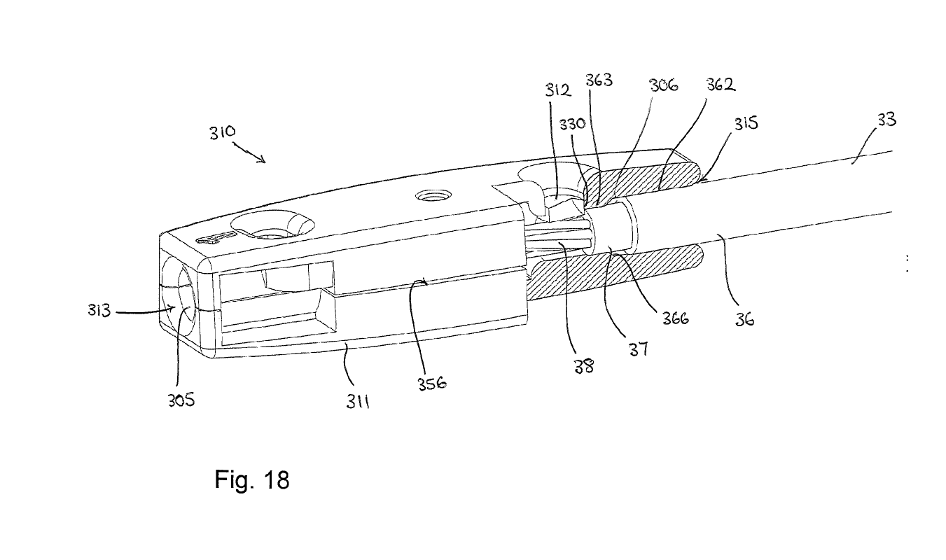

In this embodiment, each cutting blade 312 has a cutting edge 330 (shown in FIG. 18) defined by facets of the blade at the cutting end thereof, the cutting end projecting into the respective bore with the cutting edge 330 accurately positioned within the respective jaw, such that the cutting edge cuts into the adjacent cable layer to an accurately pre-defined depth, defined by the formation of the jaw from which the blade projects.

The facets of the cutting edge 330 of the blade 312 lie at an angle to the axis of the respective bore so that on pushing the cable end into the bore and rotating the tool 310 around the cable 33, the blade 312 is caused to perform a helical cutting action, in effect threading itself along the cable 33 while partly cutting and partly shearing a strip of the adjacent layer of the cable. The severed helical strip 34 exits the tool through an aperture 325 formed in the jaw of the tool 310 holding the cutting blade 312, the second pair of jaws being similarly configured and also having an aperture 325 through which the severed helical strip leaves those jaws.

Though not shown in the drawings, an internal wall extends transversely within the tool main body 311, separating the first bore 305 from the second bore 306. To both sides of that wall, the tool body 311 is formed to provide internal enlarged spaces as compared to the sizes of the openings or the diameters of the bores 305, 306 within the jaws 359, 360.

FIG. 12 shows an initial state of the tool 310, with the confronting faces 356 of each pair 359, 360 of opposed jaws in contact with each other. Though not shown, in some embodiments, it would be possible to have a small clearance gap between the jaws when the jaws are in their initial position. On pushing a cable 33 to enter or insert the cable end into the opening 313 defined by the first pair of jaws 359, the jaws 359 are sprung apart to a small extent by resilient deformation of the plastics material of the body 311, sufficient to allow the cable 33 to be entered into the opening 313, with the formations defining the opening fitting closely against the outer surface of the cable 33. This generates a small gap 364 between the jaws, as shown in FIG. 13. In other words, because the two parts 354, 355 of the main body 311 are only connected together in a central region 357 of the main body 311, at the ends 303, 304 of each of the pairs of jaws 359, 360 the two parts 354, 355 are able to flex to accommodate a cable end inserted into the respective opening 313, 315. A cable end having a larger diameter will push the two parts 354, 355 further apart resulting in a larger gap 364 between the jaws. The resilient or elastic nature of the material from which the main body 311 is made, however, means that there is a restoring force in the jaws urging the jaws closer together. This means that the jaws will tend to clamp or grip a cable 33 in the opening 313, 315.

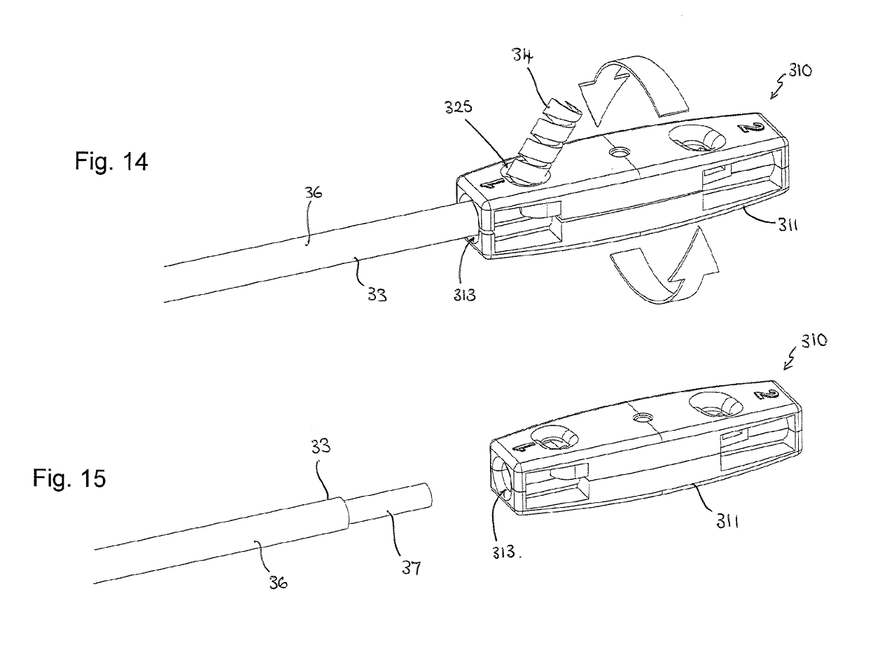

FIG. 14 shows the tool 310 being rotated about the cable 33 received in the first opening 313, such that the facets of the cutting blade partly cut and partly shear a helical strip 34 of outer sheath from the end of the cable, the severed sheath leaving the tool 310 through aperture 325. In view of the facets of the cutting blade defining the cutting edge being disposed at an angle to the axis of the bore 305, the tool 310 threads itself along the cable 33 until the free end of the cable abuts the internal transverse wall (not shown) provided within the tool 310. The tool 310 can then no longer thread itself along the cable 33 and so continued rotation is in a radial plane with respect to the cable and the cutting blade makes a circumferential cut, completely severing the strip of outer sheath from the cable. FIG. 15 shows the cable 33 pulled out of the first opening 313 of the tool 310 with the first strip, i.e. removal of part of the outer sheath 36, fully completed.

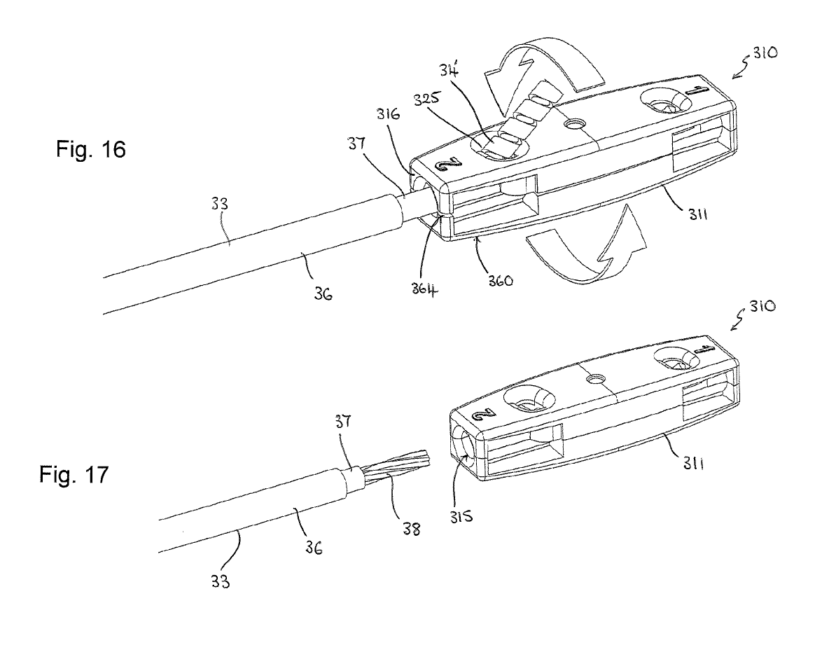

The end of the cable 33 is then inserted into the second opening 315 defined by the second pair of jaws 360 of the tool 310. In a similar manner to that described above, the confronting faces 356 (shown as curved) of the second pair of jaws 360 defining the second opening 315 are initially in contact (though perhaps with a small clearance therebetween, as mentioned above). On pushing or inserting the cable end into the opening 315, the jaws 360 are sprung apart to a small extent by resilient deformation of the plastics material of the jaws. This generates a small gap 364 between the jaws 360, as shown in FIG. 16, with the formations fitting closely against the outer surfaces of the cable end. The outer section 362 of the bore 306 fits closely against the outer sheath 36 of the cable 33 and the inner section 363 of the bore 306 fits closely against the layer of insulation 37 around the core of conductors 38 of the cable 33, which was exposed in the first strip. As with the first strip, the tool 310 is rotated about the cable 33 so as to cut a helical strip 34′ of insulation from the cable 33. That strip 34′ exits the tool 310 through the aperture 325 adjacent the cutting blade of the second pair of jaws 360. Rotation of the tool 310 is continued until the free end of the conducting core 38 abuts the transverse wall within the tool 310; the tool can then no longer thread itself along the cable 33 so that continued rotation of the tool 310 performs a circumferential cut in a radial plane thereby completely severing the strip from the cable end. FIG. 17 shows the cable 33 pulled out of the second opening 315 of the tool 310 with the two level strip fully completed, exposing a pre-determined length of conductors 38 and a predetermined length of insulation 37.

FIG. 18 shows a partly cut-away view of the tool 310 in the region of the second opening 315, together with a cable 33 inserted therein at the completion of the second strip to remove the pre-determined length of insulation 37 from the conductors 38. As can be seen, the formations or channels in the opposing faces of the second pair of opposed jaws 360 define essentially cylindrical outer and inner sections 362, 363 of a bore 306, there being a step or shoulder 366 between the outer and inner sections 362, 363. The diameter of the outer section 362 of the bore 306 is essentially equal to the anticipated diameter of the outer sheath 36 of a cable 33 with which the tool 310 is to be used, when at the smallest end of the manufacturing tolerances for such cables. Similarly, the diameter of the inner section 363 of the bore 306 is no smaller than the anticipated diameter of the inner insulation 37 of a cable 33 with which the tool 310 is to be used, when at the smallest end of the manufacturing tolerances for such cables. In practice, most cables will be slightly larger than the smallest anticipated diameter and some cables might be at the largest end of the manufacturing tolerances for such cables. Further, cables from different manufacturers may have slightly different sizes for the layers of insulation and outer sheath, for the same conductor core sizes. Whichever cable is to be stripped, on pushing the cable end into the opening 313, 315 the jaws 359, 360 will be sprung apart slightly to allow accommodation of that cable end with the formations defining the opening 313, 315 fitting closely to the cable end, as shown in FIGS. 14, 16 and 18, so ensuring an effective strip. It should be noted that the inner section 363 of the bore 306 serves to support the cable end being stripped to ensure the cutting action does not damage the conductors 38 while effectively removing the insulation layer 37.

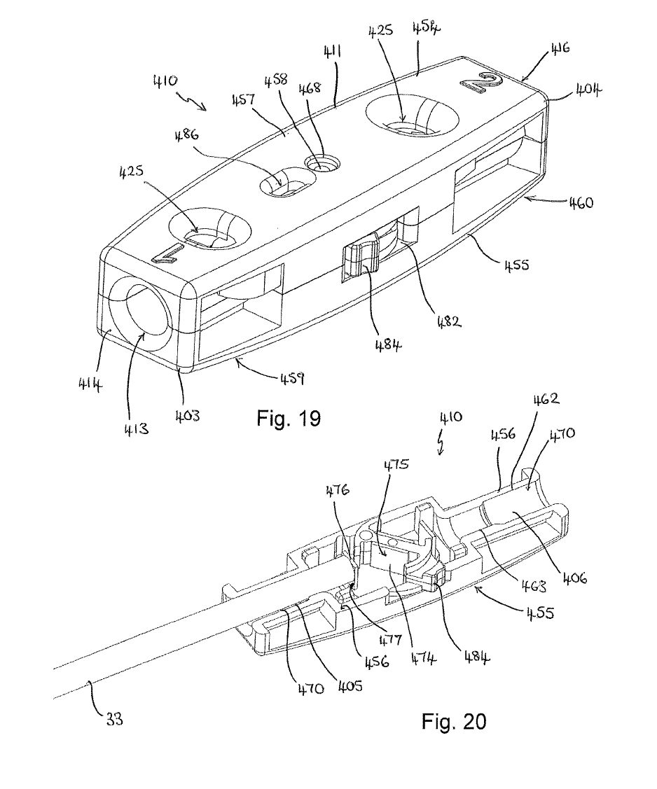

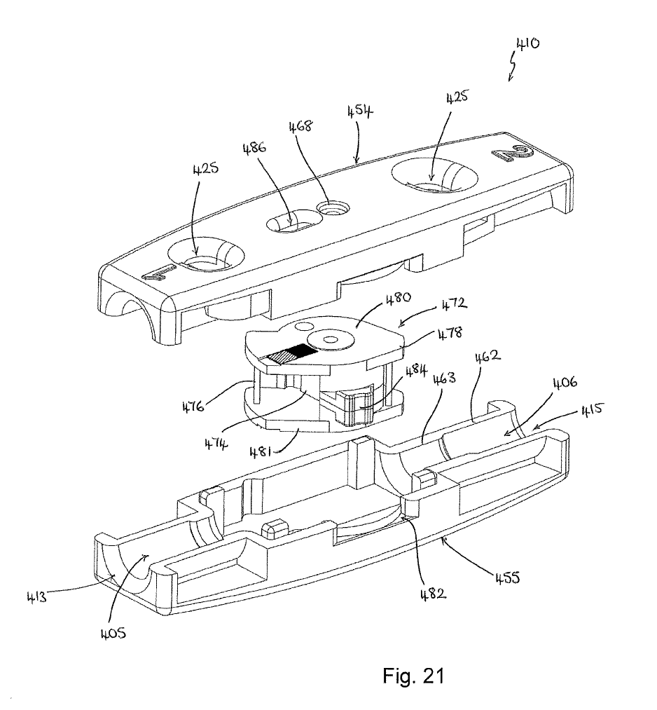

A further embodiment of a cable or wire stripping tool 410 according to this invention is shown in FIGS. 19 to 24b and comprises a hand tool configured to perform a two-level strip on a cable 33 having an inner conducting core, a layer of insulation around the core and an outer sheath surrounding the insulation.

The wire stripping tool comprises a main body 411 comprising two parts or two longitudinal halves 454, 455. The main body 411 is elongate extending between first and second ends 403, 404. The main body 411 is preferably made of a suitable plastics material and will typically be injection moulded. The two parts 454, 455 of the main body 411 have confronting or opposing faces 456, which may be substantially planar or curved. The two parts 454, 455 are fixed or clamped together in a central region 457 substantially midway between the first and second ends 403, 404 of the main body 411. In this embodiment the two parts 454, 455 are connected together by means of a rivet or post 458 which passes through a hole 468 formed in each of the two parts 454, 455. In this way, the main body 411 includes a central region 457 from which aligned first and second pairs of opposed jaws 459, 460 project in opposite directions, terminating at first and second end faces 414, 416 of the main body 411. Each jaw includes a section of each of the two parts 454, 455.

The confronting faces 456 of each pair of opposed jaws 459, 460 have formations therein in the form of channels 470 having a semi-circular cross-sectional shape. Accordingly, when the two parts 454, 455 are connected, the opposed channels 470 align in each pair of opposed jaws 459, 460 to create a bore 405, 406 having a substantially circular cross-sectional shape. Generally circular cable-receiving openings 413, 415 are, therefore, defined in the first and second end faces 414, 416 of the main body 411. A first bore 405 in the first pair 459 of opposed jaws has a substantially uniform cross-section, and a second bore 406 in the second pair 460 of opposed jaws has a stepped profile such that the bore 406 has an outer section 462 nearest the opening 415 of substantially the same cross-section as the first bore 405 and an inner section 463 furthest from the opening 415 of a lesser or smaller cross-section.

In each upper jaw there is provided a respective cutting blade (not shown) arranged to sever or cut a layer (either the outer sheath or the insulation layer) from a cable 33 inserted into an opening 313, 315, when the tool 310 is rotated about that cable 33, as described below. Each cutting blade has a cutting edge disposed in the respective bore 405, 406 at an accurately defined position, such that the cutting edge cuts into the adjacent cable layer to a precise depth, defined by the formation of the jaw from which the blade projects.

The facets of the cutting blade defining the cutting edge lie at an angle to the axis of the respective bore 405, 406 so that on inserting the cable end into the bore and rotating the tool around the cable in the correct sense, the blade performs a helical cutting action. By rotating the tool 410 and urging it along the cable 33, the tool 410 in effect is threaded along the cable while cutting and possibly partly shearing a strip of the adjacent layer of the cable. The severed helical strip is lifted by a ramp surface of the cutting blade to exit the tool 410 through an aperture 425 formed in the jaw of the tool 410 holding the cutting blade. The upper jaw of each pair 459, 460 is similarly configured and, as shown, both upper jaws have an aperture 425 through which a severed helical strip exits the respective jaw.

The tool main body 411 is formed internally to provide an enlarged space at an end of each of the bores 405, 406 as compared to the sizes of the bores 405, 406 themselves within the jaws, to allow for some splaying of the conductors in a case where a previously connected cable is to be dressed to a new strip specification. Within that enlarged space there is provided an end stop arrangement or end stop assembly 472 in communication or engaged with each bore 405, 406. The end stop arrangement 472 limits the extent to which the tool 410 may be advanced along the cable 33 by virtue of an end of the cable 33 contacting a selected abutment 474, 476 forming a part of the end stop arrangement 472.

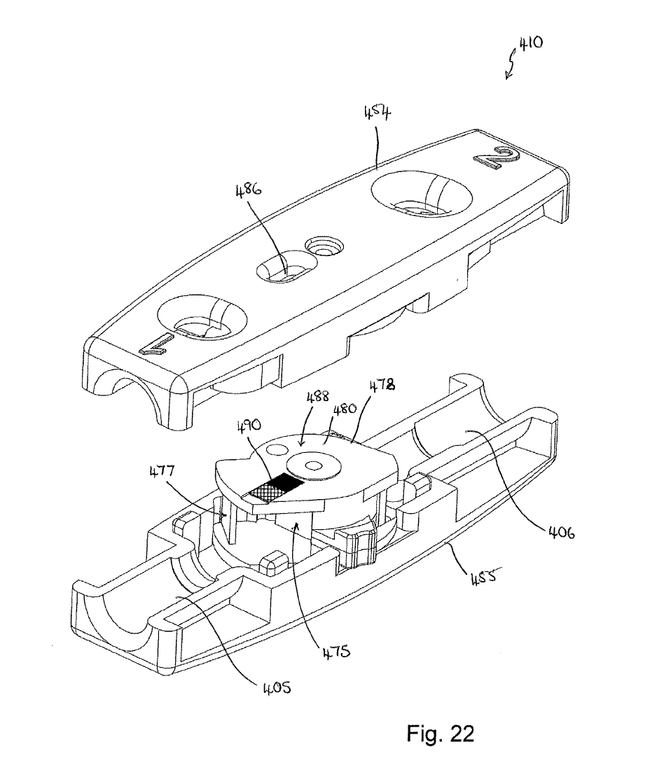

The end stop arrangement comprises a carrier or chassis 478 mounted within the tool body 411 for rotation about the rivet or post extending through the hole 468 and holding together the two parts 454, 455 of the main body 411. In other embodiments the carrier 478 may be mounted for rotation by any other suitable means. The configuration of the carrier 478 is best appreciated from FIGS. 22 to 24b and as shown, the carrier 478 has a pair of spaced cheeks or support plates 480, 481, there being two pairs of end stops in the form of abutments 474, 476 provided between those support plates 480, 481.

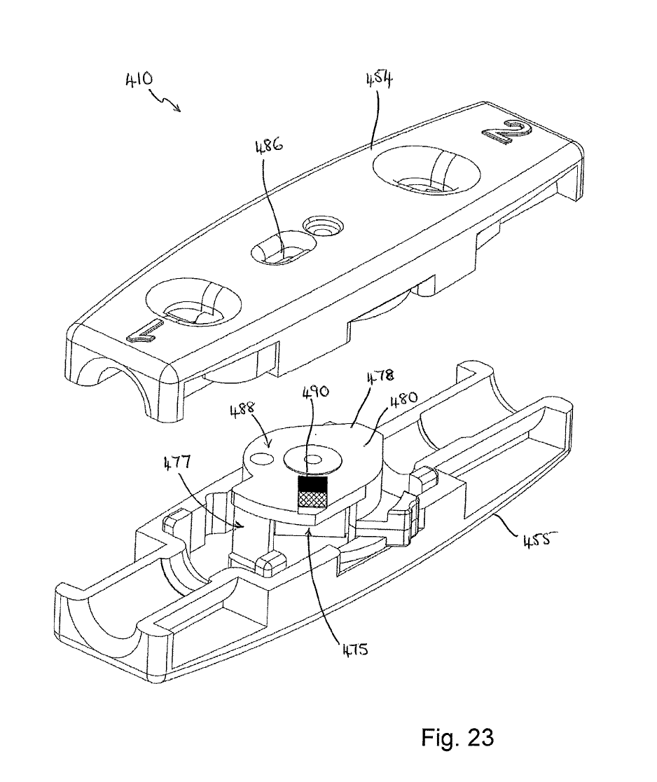

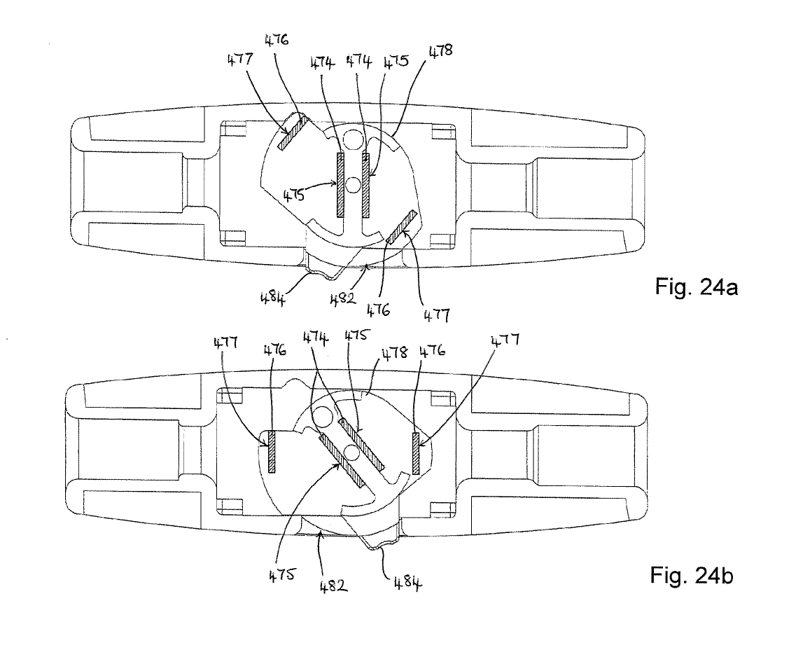

Each pair of end stops 474, 476 comprises angularly-spaced abutment surfaces 475, 477 disposed at different radii with respect to the rotational axis of the carrier 478. In particular, a first abutment surface 475 of each pair is located closer to the rotational axis of the carrier 478 than a second abutment surface 477. The end stops 474, 476 may be formed integrally with the carrier 478 or may be separate inserts made of a harder or tougher material, perhaps of metal or a ceramic, which are fitted to the carrier 478. Rotation of the carrier 478 brings either a first abutment surface 475 or a second abutment surface 477 into alignment with each of the circular openings 413, 415 and the corresponding bores 405, 406 defined by the main body 411 for receiving a cable end portion. The abutment surfaces 475, 477 are positioned so as to limit the length of the end portion of the cable which may be inserted into each of the bores 405, 406. As shown in FIGS. 22 and 24a, with the carrier 478 in a first position the two first abutment surfaces 475 are aligned with the bores 405, 406. The carrier 478 may then be turned or rotated to a second position, shown in FIGS. 23 and 24b, in which the second abutment surfaces 477 move into alignment with the bores 405, 406 respectively, so reducing the length of cable that can be inserted into the respective opening before the end face of the cable engages the abutment surface 477.

The carrier 478 further comprises a tab or slider 484 which projects through a slot 482 in a side wall in the main body 411. The tab or slider 484 extends from the main body 411 through the slot 482 such that a user's finger pressure on the slider 484 can move the slider 484 from one end of the slot 482 to the other which in turn rotates the carrier 478 between the first and second positions. Moving the tab 484 and rotating the carrier 478, therefore, switches the tool 410 between the two pre-set strip lengths for each opening 413, 415, by bringing either the two first abutments 474 into alignment with the bores 405, 406 (FIGS. 22 and 24a) or the two second abutments 476 into alignment with the bores 405, 406 (FIGS. 23 and 24b).

FIG. 20 shows a cable end portion positioned in a bore 405 of the tool 410, with the end face of the cable 33 engaging or contacting the second abutment surface 477, and so nearing the end of a stripping action. Further rotation of the tool 410 around the cable end portion will perform a simple circular cut in a radial plane on the surrounding layer of the cable 33 as the tool 410 cannot be moved further along the cable 33 in view of the engagement between the end face of the cable and the abutment 476.

As can be seen from the drawings showing the upper or first part 454 of the tool main body 411, there is a window 486 in that upper part 454 through which an upper side 488 of a support plate 480 of the carrier 478 can be viewed. The upper support plate 480 of the carrier 478 has an indicator 490 which may be exposed through the window 486 depending on the rotational setting of the carrier 478. That indicator 490 may have brown and blue coloured panels which will be exposed through the window 486 when the carrier 478 is in the first position shown in FIG. 22 thus indicating to a user that the tool 410 is in the correct setting for performing a first pre-set strip specification. When the carrier 478 is turned or rotated counter-clockwise to the second position shown in FIG. 23, the indicator 490 is no longer exposed thus indicating to a user that the tool 410 is in the correct setting for performing a second pre-set strip specification.

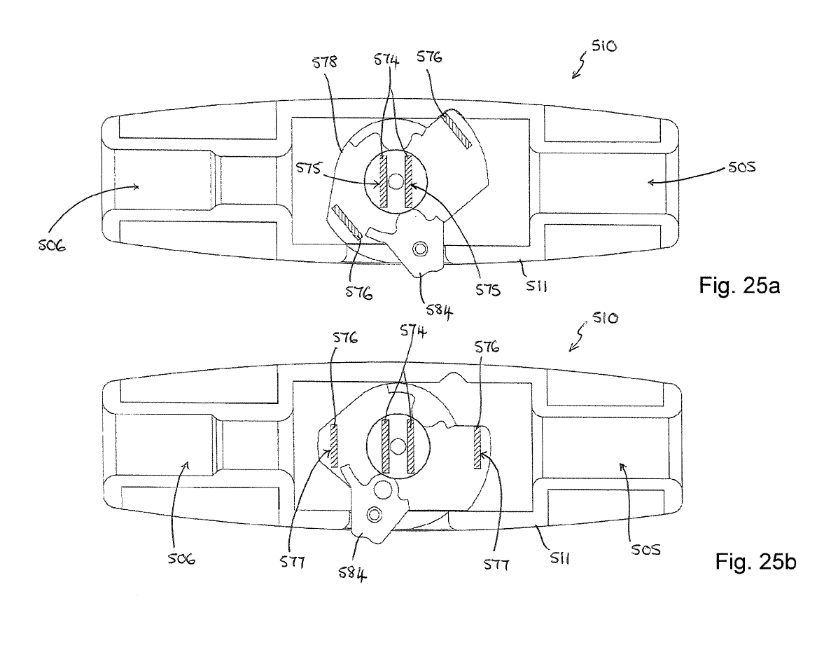

FIGS. 25a and 25b show an alternative form of a carrier 578 in a further embodiment of a cable stripping tool 510. The carrier is similar to the carrier described above and like parts are given reference numerals incremented by 100, and will not be described in further detail again here. In this embodiment, the rotatable carrier 578 is provided with only the second abutments 576. The first abutments 574 are provided on a non-rotatable boss 592 formed in the tool main body 511 around the hole 568. When the carrier 578 is turned to a first position shown in FIG. 25a, the first abutments 574 are aligned with the bores 505, 506 and first abutment surfaces 575 will be contacted by the end face of a cable when inserted sufficiently far into the respective bore 505, 506. Turning or rotating the carrier 578 by means of the tab 584 to the second position shown in

FIG. 25b brings the second abutments 576 into alignment with the respective bores 505, 506 so reducing the length of the cable which may be inserted into the bores 505, 506 before the cable end face contacts the respective second abutment surface 577. In this embodiment, the tab 584 is formed separately from the carrier 578 but is interlocked therewith.

The use of a cable cutting tool 410, 510 including a carrier 478, 578 as described above and including a cutting blade as illustrated in FIGS. 9 to 11 will now be described. FIG. 19 shows the initial state of one embodiment of the tool 410, with the confronting faces 456 of each pair of opposed jaws 459, 460 in contact with each other. Though not shown, it would be possible to have a small clearance gap between the jaws when the jaws are in their initial position. On pushing a cable end portion to enter the opening 413 defined by the first pair of jaws 459, the jaws are sprung apart to a small extent by resilient deformation of the plastics material of the body 411, sufficient to allow the cable 33 to be entered into the opening 413 until the knife part of the blade of the tool 410 engages the end of the cable 33. The tool 410 is then rotated in the correct sense about the cable 33, such that the knife part of the cutting blade cuts a helical strip of outer sheath from the end of the cable, the severed sheath being lifted by the ramp surface of the base part to leave the tool 410 through the aperture 425. At the same time as the tool 410 is rotated, pressure is applied to the tool 410 in the direction along the length of the cable away from the free end thereof. In view of the facets of the cutting blade defining the cutting edge being disposed at an angle to a true radial plane of the opening, the tool 410 moves along the cable 33 creating a helical cut in the sheath until the free end of the cable comes into engagement with the first abutment surface 475 of the carrier 478. The tool 410 can then no longer move along the cable 33 and so, on continued rotation, the tool 410 causes the cutting blade to make a circumferential cut, completely severing the strip of outer sheath from the cable 33.

Following completion of the strip of the outer sheath, the end portion of the cable is withdrawn from the opening 413 and the carrier 478 is turned from the first position shown in FIG. 22 to the second position shown in FIG. 23. The cable end portion is then inserted into the second opening 415 defined by the second pair of jaws 460 of the tool 410. In a similar manner to that described above, the confronting faces 456 (shown as curved) of the second pair of jaws 460 defining the bore 406 are initially in contact (though perhaps with a small clearance therebetween, as mentioned above) but on pushing the cable end into the opening 415, the jaws are sprung apart to a small extent by resilient deformation of the plastics material of the jaws. The outer section 462 of the bore 406 fits closely against the outer sheath of the cable 33 and the inner section 463 of the bore 406 fits closely against the layer of insulation around the core of conductors of the cable exposed in the first strip.

As with the first strip, the tool 410 is rotated about the cable 33 so as to cut a helical strip of insulation from the cable, that strip exiting the tool through the aperture 425 adjacent the cutting blade of the second pair of jaws 460. Rotation is continued until the free end of the conducting core comes into engagement with the second abutment surface 477 as shown in FIG. 20. The tool 410 can then no longer be moved along the cable 33 so that continued rotation of the tool 410 performs a circumferential cut in a radial plane thereby completely severing the strip of insulation from the cable end.

It will be appreciated that although in the described embodiments of the cable stripping tool 410, 510 there are two abutments 474, 476, 574, 576 either of which can be aligned with a corresponding bore 405, 406, 505, 506, it would be possible to have more than two abutments any one of which could be selected to serve as a stop for a cable end portion being stripped. Furthermore, a rotatable carrier may be used in a tool having a unitary main body or a two part main body.

Further, it will be appreciated that any of the cutting blades described above may be combined with any one of the main bodies of the tools described above.

In some embodiments of a cable stripping tool according to the invention the main body may comprise a single bore for receiving a cable end or more than two bores sized to receive cables having different outer diameters. In preferred embodiments, however, the tool includes two bores as described in the examples above. Preferably an axis of each of the bores is parallel to, and most preferably co-axial with, the axis of the elongate main body of the cable stripping tool.

The present invention, therefore, provides a tool for stripping a surrounding layer from a cable which is simple and cost effective to manufacture and has few parts, but which provides an accurate and precise stripping action for stripping either the outer sheath or the insulation from the cable.

What is claimed is:

1. A tool for stripping a sheath from a sheathed elongate cable of substantially circular cross-sectional shape, comprising:
a tool body having a bore for receiving an end portion of a cable to be stripped;
a cutting blade having a cutting end and a rear end opposed to the cutting end, the cutting blade being mounted in a slot within the tool body with the cutting end accurately positioned and aligned in the bore to sever a helical strip of sheath from the end portion of a cable received in the opening on rotating the tool around the cable;
characterised in that the slot houses the cutting blade and has an open end, the blade being slidably received, rear end first, in the slot from the open end thereof and an abutment within the slot is engaged by the rear end of the blade whereby the cutting end is accurately positioned and aligned within the bore.

2. A tool as claimed in claim 1, wherein an end of the slot remote from the open end thereof is essentially closed.

3. A tool as claimed in claim 2, wherein a transverse wall extends across said closed end of the slot, the transverse wall defining the abutment for engagement by the rear end of the cutting blade.

4. A tool as claimed in claim 3, wherein the transverse wall has a concave surface within the slot, and the rear end of the cutting blade is convex for engagement with the concave surface of the transverse wall.

5. A tool as claimed in claim 1, wherein the abutment is defined by a projection from the tool body, within the slot.

6. A tool as claimed in claim 1, wherein the slot has a cross-section complementary to the cross-section of the cutting blade whereby the cutting blade is constrained against movement other than in the direction between its cutting and rear ends.

7. A tool as claimed in claim 6, wherein the slot has side walls extending from the open end thereof to the remote end of the slot, and the cutting blade has side flanks extending between the cutting and rear ends thereof, each side flank being a sliding fit against the corresponding wall of the slot.

8. A tool as claimed in claim 1, wherein the slot is defined by side walls and a channel is formed in one of the side walls, extending along the length thereof to give access to a cutting blade located in the slot.

9. A tool as claimed in claim 1, wherein an aperture is formed through a side face of the tool to communicate with the cutting end of the cutting blade whereby sheath cut from a cable may leave the bore through the aperture.

10. A tool as claimed in claim 1, wherein the bore has an end wall defining the maximum insertion depth of a cable end portion being stripped.

11. A tool as claimed in claim 1, wherein the bore has two slots associated therewith, at substantially diametrically-opposed locations and arranged to sever sheath at two different radii with respect to the cable end portion.

12. A tool as claimed in claim 11, wherein the axial location of the two slots is different whereby a two-level strip of sheath is obtained by use of the tool.

13. A tool as claimed in claim 1, wherein the bore is cylindrical and of a diameter adapted to receive a known cable size.

14. A tool as claimed in claim 1, wherein the tool body has two opposed axially-aligned bores for receiving an end portion of a cable to be stripped, each having at least one slot associated therewith.

15. A tool as claimed in claim 14, wherein the two bores are of different diameters, each adapted to receive a known but different cable size.

16. A tool as claimed in claim 1, wherein the cutting blade has facets which define the cutting edge of the blade and the blade is mounted in the tool body such that the cutting edge extends along a chord of the bore with the cutting edge lying in a non-radial plane whereby rotation of the tool about a cable end portion received in the opening causes the tool to create a helical cut along the cable end portion, thereby severing a helical strip of the surrounding layer as the tool moves along the cable end portion.

17. A tool as claimed in claim 1, wherein the cutting blade has a further edge extending generally at right angles to the cutting edge and lying in a plane which is parallel to an axis of a cable inserted into the bore.
